(19) United States
(12) Patent Application Publication
(10) Pub. No.: US 2018/0193716 A1
(43) Pub. Date: Jul. 12, 2018

(54) ELECTRONIC SCOREBOARD

(71) Applicants: Chris Mayotte, Norwalk, CT (US); Khattar Hashim, Norwalk, CT (US); Glen Sansone, Norwalk, CT (US); Nishant Kumar, Bergenfield, NJ (US); Frank Arundell, Tarrytown, NY (US)

(72) Inventors: Chris Mayotte, Norwalk, CT (US); Khattar Hashim, Norwalk, CT (US); Glen Sansone, Norwalk, CT (US); Nishant Kumar, Bergenfield, NJ (US); Frank Arundell, Tarrytown, NY (US)

(21) Appl. No.: 15/833,637

(22) Filed: Dec. 6, 2017

Related U.S. Application Data
(60) Provisional application No. 62/430,743, filed on Dec. 6, 2016.

(51) Int. Cl. A63B 71/06; A63B 24/00

(52) U.S. Cl. CPC A63B 71/0669; G01V 8/10; A63B 24/0062

(57) ABSTRACT

A scoreboard is disclosed comprising a scoreboard body having first player identification indicia, second player identification indicia, and scoring indicia. The scoreboard includes first and second player indicators that are movable for indicating a current score of the first or player. A first detection device for recording manual movement of the first player indicator indicates a score change of the first player, and a second detection device for recording manual movement of the second player indicator indicates a score change of the second player. A master controller is operatively connected to the detection devices, that are configured to send signals to the master controller. The master controller is configured to perform at least one of the following operations: (a) store the current score of each of the first and second players; and (b) transmit the current score of each of the first and second players over a network.

### CROSS-REFERENCE TO RELATED APPLICATION

The present application claims the benefit of U.S. Patent Application Ser. No. 62/430,743, filed Dec. 6, 2016, which is hereby incorporated by reference in its entirety.

### TECHNICAL FIELD

The present invention is directed to a scoreboard and more specifically, is directed to an electronic scoreboard, such as a tennis scoreboard, that is configured to transmit data over a network.

### BACKGROUND

A scoreboard is generally a board for publicly displaying the score in a game or contest. Most levels of sport from junior high school organized sports to amateur and professional sports, along with organized sports, use at least one scoreboard for keeping score, measuring time, and displaying statistics. Traditional scoreboards used a mechanical clock and numerical cards to display the score and/or other information. Many traditional scoreboards were manual in nature in that a person would manually change the information being displayed. A popular example of such a scoreboard is the scoreboard in Fenway Park. Overtime, scoreboards have become more advanced and now electronic scoreboards are the norm. These electronic scoreboards can take any number of different forms, but typically include a digital display, such as an HD display, which digitally displays the score and other information.

While digital scoreboards have value, it is desirable, in at least certain settings, to be able to maintain the traditional look of a manual scoreboard; however, provide enhancements to the scoreboard that allow automation in score reporting and in particular, permit information displayed on the scoreboard to be transmitted over a network to allow for compiling and display of scores from multiple games, multiple settings, etc.

### SUMMARY

In one embodiment, a scoreboard includes a scoreboard body having first player identification indicia, second player identification indicia, and scoring indicia. The scoreboard also includes a first player indicator that is movable relative to the scoreboard body for indicating a current score of a first player and a second player indicator that is movable relative to the scoreboard body for indicating a current score of a second player.

At least one first detection device is provided for recording manual movement of the first player indicator which indicates a change in the current score of the first player and at least one second detection device is provided for recording manual movement of the second player indicator which indicates a change in the current score of the second player. A master controller is operatively connected to the at least one first detection device and the at least one second detection device. The at least one first detection device is configured to send a signal to the master controller when the at least one first detection device detects the first player indicator, the at least one second detection device being configured to send a signal to the master controller when the at least one second detection device detects the second player indicator. The master controller is also configured to perform at least one of the following operations: (a) store the current score of each of the first and second players; and (b) transmit the current score of each of the first and second players over a network.

In yet another implementation, the present application includes a networked scoreboard system, comprising one or more processors operatively coupled to a memory that stores instructions for causing the following steps to be performed by the one or more processors. At least one of game information, participant information, and league information, associated with a respective game being played or to be played is received, over a communication network from at least one computing device. In addition, score information representing a change in a score of the game, is received over a communication network substantially in real-time during gameplay of the game, wherein the score information is received from a master controller that is configured with a scoreboard, in response to an electronic detection of a location or a change in location of an indicator configured with the scoreboard. The received score information is processed and transmitted over a communication network to at least one device configured with a display. The at least one device configured with the display uses the processed score information for display of a current score of the game

### BRIEF DESCRIPTION OF THE DRAWING FIGURES

FIG. 1 is a front elevation view of a scoreboard according to a first embodiment;

FIG. 2 is a rear elevation view of the scoreboard;

FIG. 3 is a close-up of a detection device along a rear of the scoreboard;

FIG. 4 is a front elevation view of a scoreboard according to a second embodiment;

FIG. 5 is a rear elevation view of the scoreboard;

FIG. 6 is a close-up of a detection device along a rear of the scoreboard;

FIG. 7 is a front elevation view of a scoreboard according to a third embodiment;

FIG. 8A is a close-up of a first detection device along a rear of the scoreboard;

FIG. 8B is a close-up of a second detection device along a rear of the scoreboard;

FIG. 9 is a rear elevation view of a scoreboard according to another embodiment;

FIG. 10 is a close-up of a detection device along a rear of the scoreboard along with a player indicator;

FIG. 11 is a front elevation view of a scoreboard according to another embodiment;

FIG. 12A is a high level overview of the scoreboard as part of a connected network, in accordance with an example embodiment;

FIG. 12B is a high level overview of the scoreboard as part of a connected network, in connection with another example embodiment;

FIG. 13A illustrates a remote computing device;

FIG. 13B is a flow diagram illustrating a method for displaying one or more real-time scores from the scoreboard on one or more displays; and

FIG. 13C is a flow diagram illustrating a method for displaying one or more real-time scores from the scoreboard on one or more remote computing devices via a mobile app

### DETAILED DESCRIPTION OF CERTAIN EMBODIMENTS

In at least some embodiments, the present invention is directed to scoreboards that are manually operated and have the traditional look of manual scoreboards; however, the scoreboards have features that allow for automation in score reporting and in particular, permit information displayed on the scoreboard to be transmitted over a network to allow for compiling and display of scores from multiple games, multiple settings, etc. In other words, the scoreboard can be part of a computer implemented system.

### Tennis Scoreboard—First Embodiment

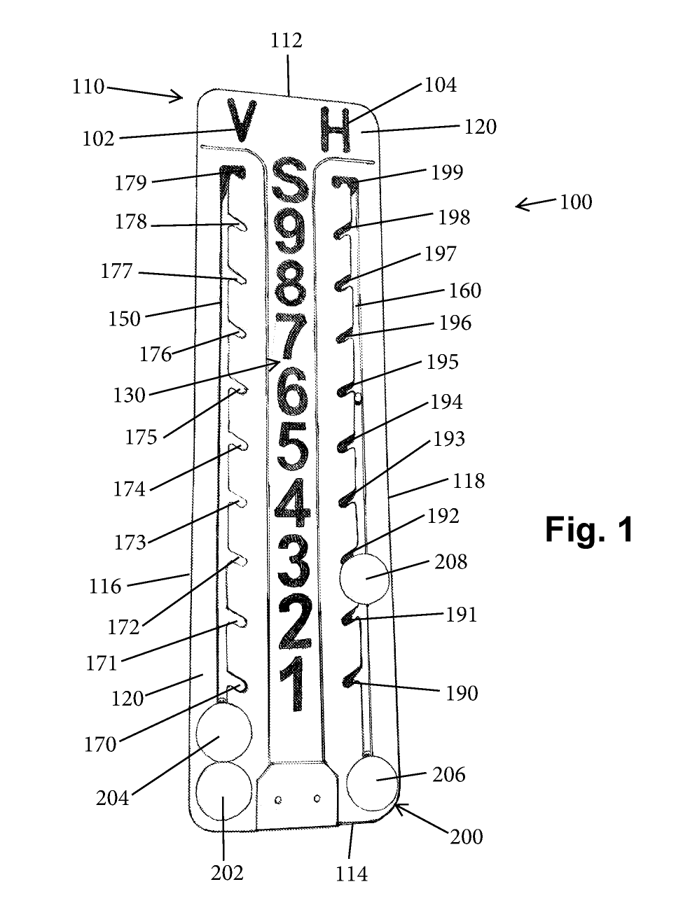

FIGS. 1-3 illustrate a scoreboard 100 according to a first embodiment that is particularly suited for use in the sport of tennis. The scoreboard 100 is configured to easily fasten to all different types of tennis net posts. The scoreboard 100 is configured to score 2-out-of-3 sets, 8 game pro set for juniors & 10 point tie-breakers; however, it will be understood that the scoreboard 100 can have other configurations and is not limited to the one illustrated and described herein. While a number of scoreboards described and illustrated herein are tennis scoreboards, the present invention is not limited to such application and the disclosed scoreboard and associated network can be applied to other sports and other settings.

The scoreboard 100 includes an elongated scoreboard body 110 that has a first end 112, an opposing second end 114, a first side edge 116, and an opposing second side edge 118. The scoreboard body 110 includes a first face (e.g., a front face) 120 and an opposing second face (e.g., a rear face) 125.

The scoreboard body 110 has two player identification and scoring indicia. More specifically, the first face 120 of the scoreboard body 110 has first player identification indicia 102 and second player identification indicia 104. The first player identification indicia 102 is indicated on the left of the scoreboard body 110 and the second player identification indicia 104. In the illustrated scoreboard 100, the first player identification indicia 102 is represented by the letter “V” for a visitor player and the second player identification indicia 104 is represented by the letter “H” for a home player. It will also be appreciated that other means can be used to visually identify one player from another. For example, another letter or number can be used to identify each player from one another. Alternatively, a personalized name plate can be used for each player and can be slid into a respective slot formed along the first face 120 of the scoreboard body 110.

The first face 120 of the scoreboard body 110 also includes scoring identification information 130 which in the illustrated embodiment is in the form of a series of numbers that are oriented vertically. In particular, the illustrated scoring identification information 130 includes the numbers 1 to 9 displayed in series and the letter S at the top above the number 9.

The scoreboard 100 includes: (a) a first track 150 which is oriented vertically along the first side edge 116 and can be in the form of a slot and (b) a second track 160 which is oriented vertically along the second side edge 118 and can be in the form of a slot. Each track 150, 160 extends from the letter S to a location below the number 1. The first track 150 includes a plurality of side tracks which are spaced apart vertically from one another and which communicate and open into the first track 150. The second track 160 includes a plurality of side tracks which are spaced apart vertically from one another and which communicate and open into the second track 160. In particular, each side track is associated with one of the scoring information indicia. More specifically, the plurality of side tracks associated with the first track 150 include a first side track 170 adjacent the 1, a second side track 171 adjacent the 2, a third side track 172 adjacent the 3, a fourth side track 173 adjacent the 4, a fifth side track 174 adjacent the 5, a sixth side track 175 adjacent the 6, a seventh side track 176 adjacent the 7, an eighth side track 177 adjacent the 8, a ninth side track 178 adjacent the 9 and a tenth side track 179 adjacent the S. Similarly, the plurality of side tracks associated with the second track 160 include a first side track 190 adjacent the 1, a second side track 191 adjacent the 2, a third side track 192 adjacent the 3, a fourth side track 193 adjacent the 4, a fifth side track 194 adjacent the 5, a sixth side track 195 adjacent the 6, a seventh side track 196 adjacent the 7, an eighth side track 197 adjacent the 8, a ninth side track 198 adjacent the 9 and a tenth side track 199 adjacent the S.

It will be appreciated that the first track 150 and the side tracks associated therewith are affiliated with the first player and the second track 160 and the side tracks associated therewith are affiliated with the second player. As a result, each player can keep score and updated the score as the game (match) progresses as described herein.

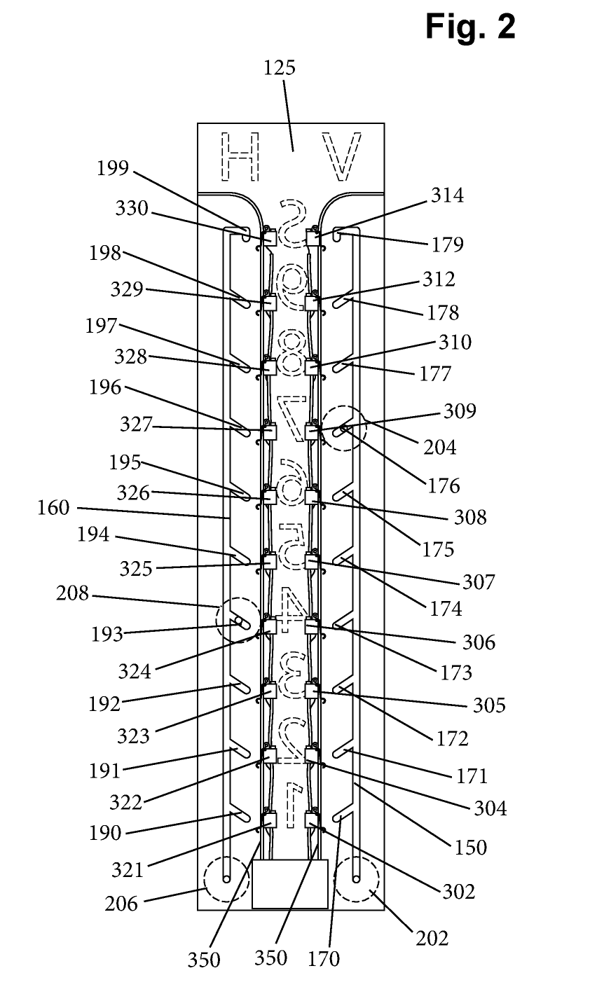

As shown in FIGS. 1 and 2, some or all of the above side tracks can be angled with respect to the respective first or second tracks 150, 160 and more particularly, some or all of the side tracks can be angled downwardly.

The scoreboard 100 further includes a plurality of indicators 200 that permit each player to score the game. More specifically, each indicator 200 is configured to move along one of the first or second tracks 150, 160 and into one of the side tracks associated therewith for indicating the score of the game (match). In one embodiment, the indicators 200 comprise first and second indicators 202, 204 which represent a first set of indicators for use by a first player; and third and fourth indicators 206, 208 which represent a second set of indicators for use by a second player. The first and second indicators 202, 204 are preferably differentiated from the third and fourth indicators 206, 208. For example, the first and second indicators 202, 204 can have a first color and the third and fourth indicators 206, 208 can have a second color. Alternatively, the first set of indicators can have a first shape and the second set of indicators can have a second shape. In the illustrated embodiment, each indicator has a circular shape and more specifically, the indicator has a first disk that is for placement along the first face 120 and a second disk that is for placement along the second face 130 and a post that extends between the two disks. The post is sized to be received within and to slidingly travel within one of the first and second tracks 150, 160 and be positioned into one of the respective side tracks, thereby permitting the indicator to be moved into the side track adjacent the respective score indicia. For example, the indicators can initially be placed in the bottom of the respective tracks 150, 160 which correspond to a score of zero (0) for each player. When one player wins the first game, the player moves the indicator assigned to that player to the first side track 170, 190 depending if the respective indicator is in the first track 150 or the second track 160. In turn, as each player wins a game, the respective indicator is moved along the first and second track and into the respective side track. Thus, as each player wins a game, the player moves the indicator up the respective track and into the side track that includes game indicia that indicates the number of the game just won by the player. For example, if the player wins his or her fifth game, then the player will move his/her indicator out of the side track 173, 193 into the respective side track 150, 160 and is then inserted into the side track 174, 194 that represents the fifth game.

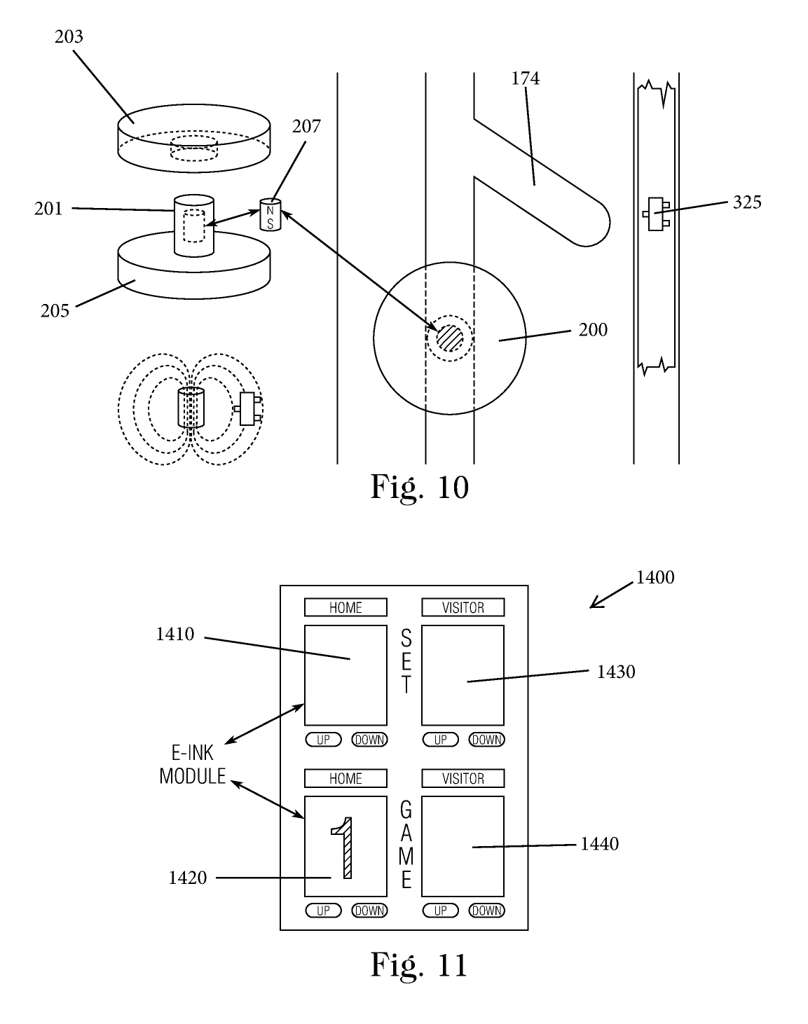

One type of indicator 200 is shown in FIG. 10. The scoreboard body 110 can be manufactured from any number of different materials, including but not limited to metal, wood, and plastics. The scoreboard 100 is sized and configured so that scores for both players (teams) are easy to read from a distance. In one embodiment, the scoreboard 100 can have the following dimensions: 8″ wide×30″ high×½″ thickness. The indicators are sized so that they are securely held within the slots that define the main tracks 150, 160 and the secondary side tracks and similarly, can easily move therein. In one embodiment, the indicator can have a two inch (2″) diameter.

In accordance with the present invention, the scoreboard 100 is an electronic scoreboard in that it includes an electronic component. More specifically and as described in detail herein, the scoreboard 100 is configured such that as the location of the indicator 200 is detectable when inserted into any one of the side tracks and also in one more locations along the main first and second track 150, 160. More specifically, each of the side tracks includes a detection device that detects the presence of the indicator 200 within the side track. The detection device can take any number of different forms, including but not limited to, mechanical sensors (e.g., a switch); optical sensors, magnetic sensors, capacitive sensors, etc. It will be appreciated that each of the side tracks 170, 171, 172, 173, 174, 175, 176, 177, 178, 179, 190, 191, 192, 193, 194, 195, 196, 197, 198, 199, has a detection device associated therewith to allow the presence of the indicator 200 therein to be detected and similarly, once the indicator is removed therefrom, the detection device detects the absence of the indicator 200 in the respective side track.

In the illustrated embodiment, the detection device is in the form of a mechanical switch (sensor) and more particularly, there are: a first detection device 302 that is associated with the first side track 170, a second detection device 304 that is associated with the second side track 171, a third detection device 305 that is associated with the third side track 172, a fourth detection device 306 that is associated with the fourth side track 173, a fifth detection device 307 that is associated with the fifth side track 174, a sixth detection device 308 that is associated with the sixth side track 175, a seventh detection device 309 that is associated with the seventh side track 176, an eighth detection device 310 that is associated with the eighth side track 177, a ninth detection device 312 that is associated with the ninth side track 178, a tenth detection device 314 that is associated with the tenth side track 179, an eleventh detection device 321 that is associated with the first side track 190, a twelfth detection device 322 that is associated with the second side track 191, a thirteenth detection device 323 that is associated with the third side track 192, a fourteenth detection device 324 that is associated with the fourth side track 193, a fifteenth detection device 325 that is associated with the fifth side track 194, a sixteenth detection device 326 that is associated with the sixth side track 195, a seventeenth detection device 327 that is associated with the seventh side track 196, an eighteenth detection device 328 that is associated with the eighth side track 197, a nineteenth detection device 329 that is associated with the ninth side track 198, a twentieth detection device 330 that is associated with the tenth side track 199.

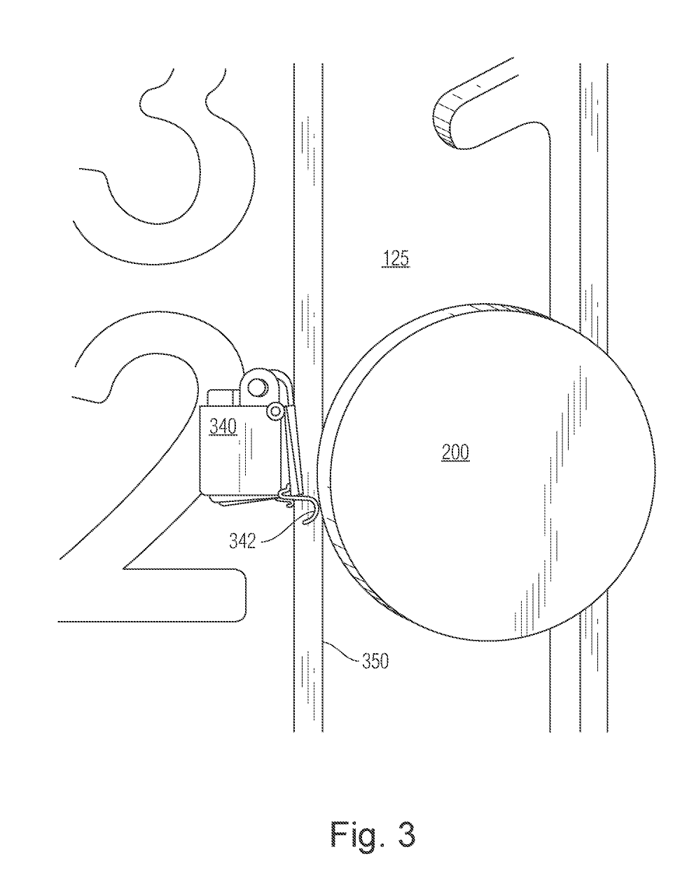

In the illustrated embodiment, illustrated in FIG. 3, in which each of the detection devices is in the form of a switch, each detection device has a body 340 that is mounted to the rear face 125 of the scoreboard body 110 and a pivotable switch element 342 that pivots relative to the body 340. The pivotable switch element 342 protrudes outwardly from the body 340 in a direction such that at least a distal end thereof is proximate the slot that defines the respective side track. The switch is positioned such that when the indicator 200 is inserted into one of the side track (slot) and is pushed to the fully inserted position, the indicator 200 makes contact with and moves the pivotable switch element 342 from an off position to an on position. The pivotable switch element 342 is biased such that when the applied force (load) of the indicator 200 is removed, the switch element 342 is biased back to the off position. The detection device (e.g., switch) is configured to send a signal indicating that it is now in the on position (e.g., due to a circuit of the switch being closed, etc.). This signal can be sent using traditional communication protocol and equipment including a wired connector of a wireless connection as described herein.

In the illustrated embodiment, each detection device can be connected via a wire 350 to a master controller (processor) 355. Thus, at any point in time, the master controller 355 knows which switches are in the on position and knows the location thereof. More specifically, each detection device has a unique identifier and the location of each uniquely identified detection device is entered (inputted) into the master controller 355 (as stored data) to allow the master controller 355 to thus know the locations of all of the detection devices. Since each detection device corresponds to specific game indicia, the score of the match (game) is readily recorded and stored by the master controller 355 when a player moves one indicator 200 into one of the side tracks to indicate the current score (and reflect a change in the game score).

Preferably the controller 355 along with other computer modules, such as a Wi-Fi transmitter, are fully integrated into the body of the scoreboard. USB ports and the like can be visible and accessible.

### Tennis Scoreboard—Second Embodiment

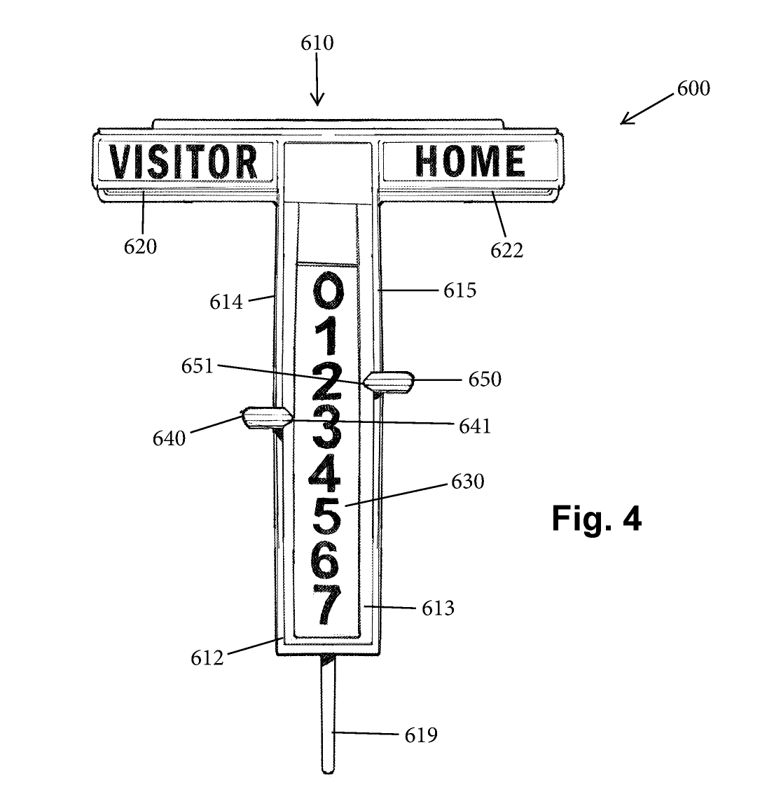

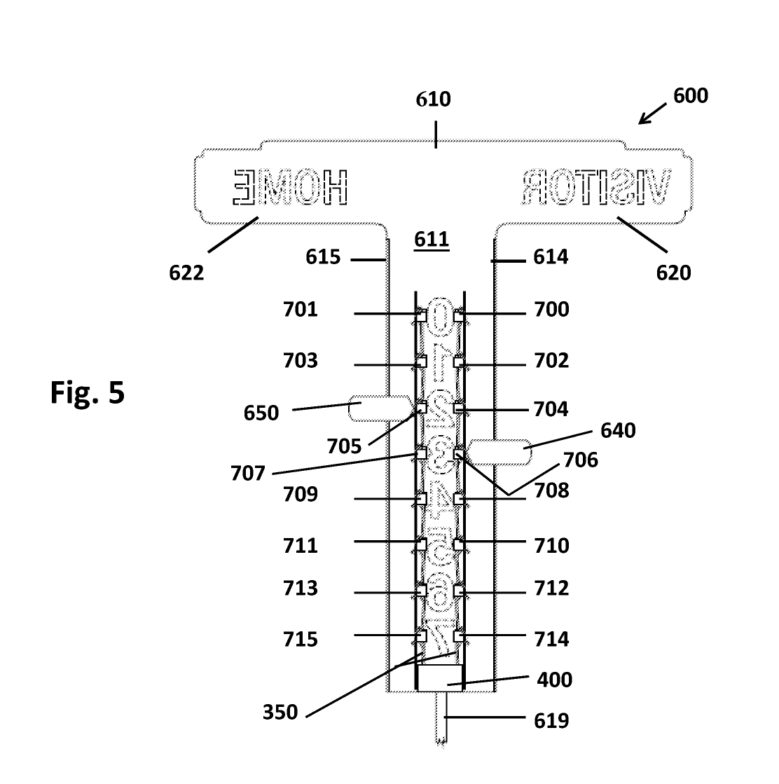

FIGS. 4-6 illustrate a scoreboard 600 according to a second embodiment; however, similar to the scoreboard 100, the scoreboard 600 is manually operated but has electronic componentry. The scoreboard 600 includes a scoreboard body 610 that has a center vertical structure 612 and first and second top side display sections 620, 622, as well as a post 619. The first and second top side display sections 620, 622 can be used to display a name of the player or can be used to display a “home” or “visitor” sign. Along a front surface (face) 613 of the center structure 612, game indicia 630 is displayed and in particular, the game indicia 630 can display numerical game information, such as “0, 1, 2, 3, 4, 5, 6 and 7” listed vertically in series. Along a first side edge (left) 614, a first player indicator 640 is provided and similarly, along a second side edge (right) 615, a second player indicator 650 is provided. In this embodiment, the first and second indicators 640, 650 are in the form of sliders that move along the respective side edge. The inner edge of each of the first and second indicators 640, 650 has a pointed tip 641, 651, respectively, that points to one of the game indicia 630.

In this embodiment and similar to the first embodiment, along a rear face 611 of the scoreboard body 610, plural detection devices are provided to detect the position of the first and second indicators 640, 650 along the center structure 612 and more particularly, along the game indicia 630. Each game number has a pair of corresponding detection devices positioned to detect the presence of one of the first and second indicators 640, 650. For example, the detection devices can include first and second detection devices 700, 701 associated with the game number 0; third and fourth detection devices 702, 703 associated with the game number 1; fifth and sixth detection devices 704, 705 associated with the game number 2; seventh and eighth detection devices 706, 707 associated with the game number 3; ninth and tenth detection devices 708, 709 associated with the game number 4; eleventh and twelfth detection devices 710, 711 associated with the game number 5; thirteenth and fourteenth detection devices 712, 713 associated with the game number 6; and fifteenth and sixteenth detection devices 714, 715 associated with game number 7. Additional game number indicia and detection devices can be provided.

The detection devices 700, 702, 704, 706, 708, 710, 712, 714 are axially positioned along the first side edge (left) 614 such that when the indicator 640 moves along the first side edge 614, the indicator 640 makes contact with one of the respective detection devices causing the detection device to move from the off position to the on position. Similarly, the detection devices 701, 703, 705, 707, 709, 711, 713, 715 are axially positioned along the second side edge (right) 615 such that when the indicator 650 moves the second side edge 615, the indicator 650 makes contact with one of the respective detection devices causing the detection device to move from the off position to the on position.

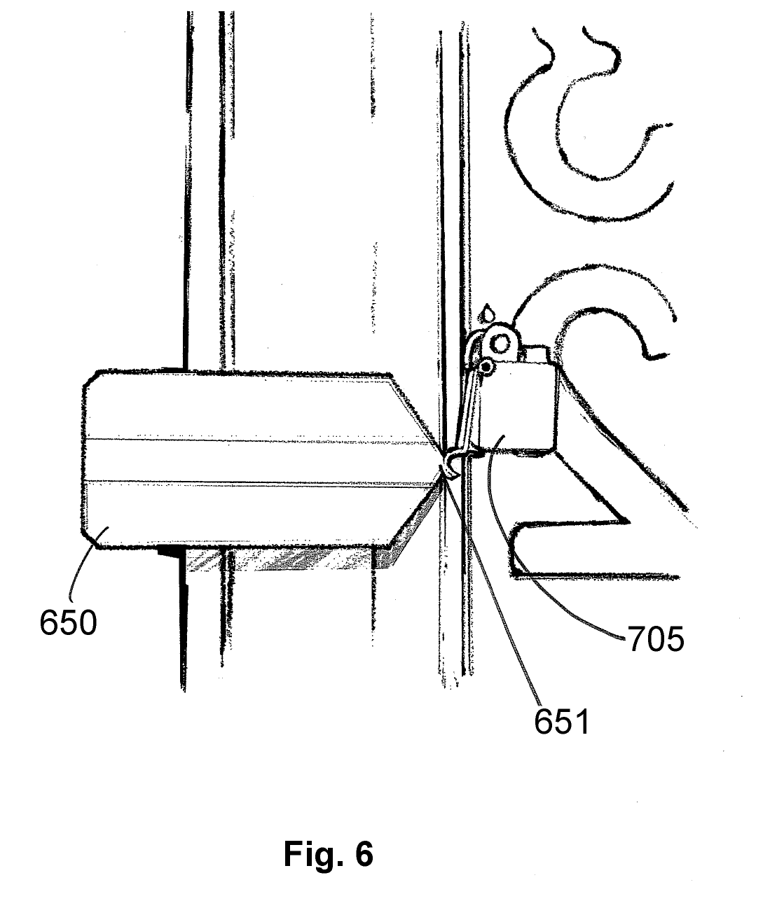

The detection devices for use in the scoreboard 600 can be of the same type that are used as the detection devices 300 in the scoreboard 100 (FIG. 6). In this embodiment, the pointed tip contacts and moves the pivotable switch element of the detection device, thereby registering the scoring change and allowing the processor to calculate the current score. Further, the detection devices for use in the scoreboard 600 are connected to the master controller 355 and as described above with respect to the scoreboard 100, the scoreboard 600 is configured such that the on/off states of all of the detection devices are known.

### Tennis Scoreboard—Third Embodiment

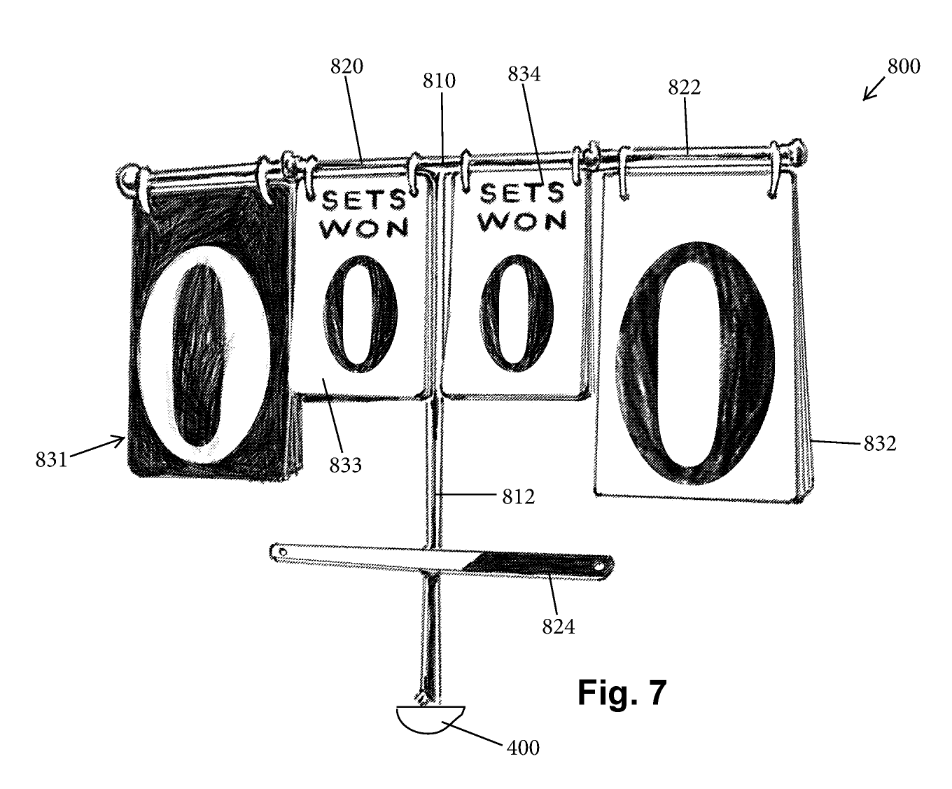

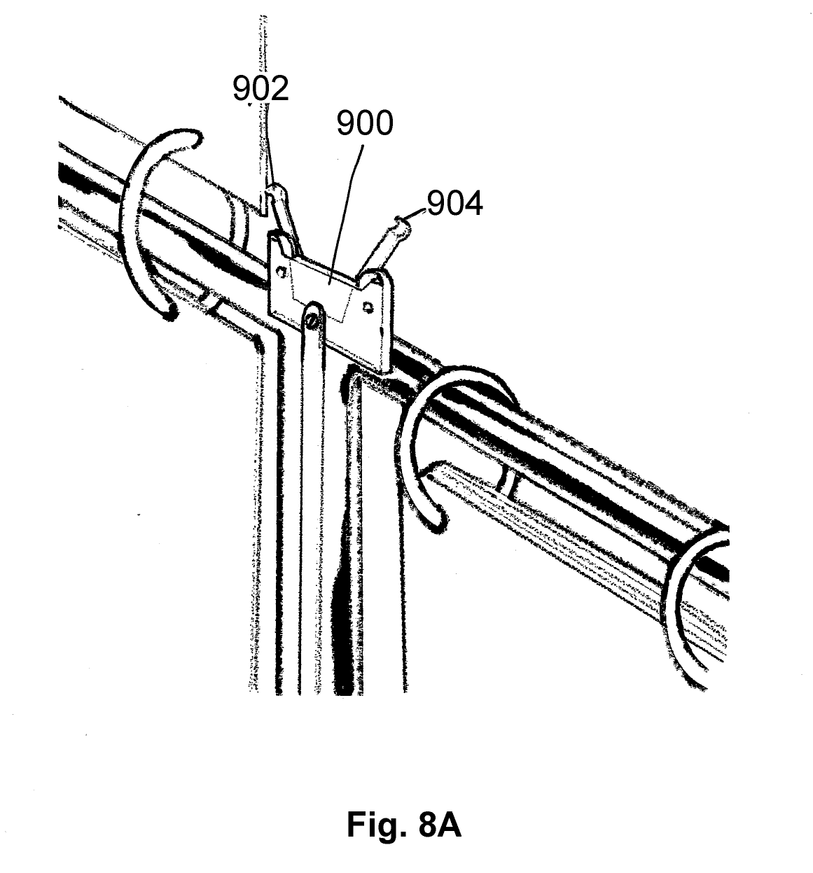

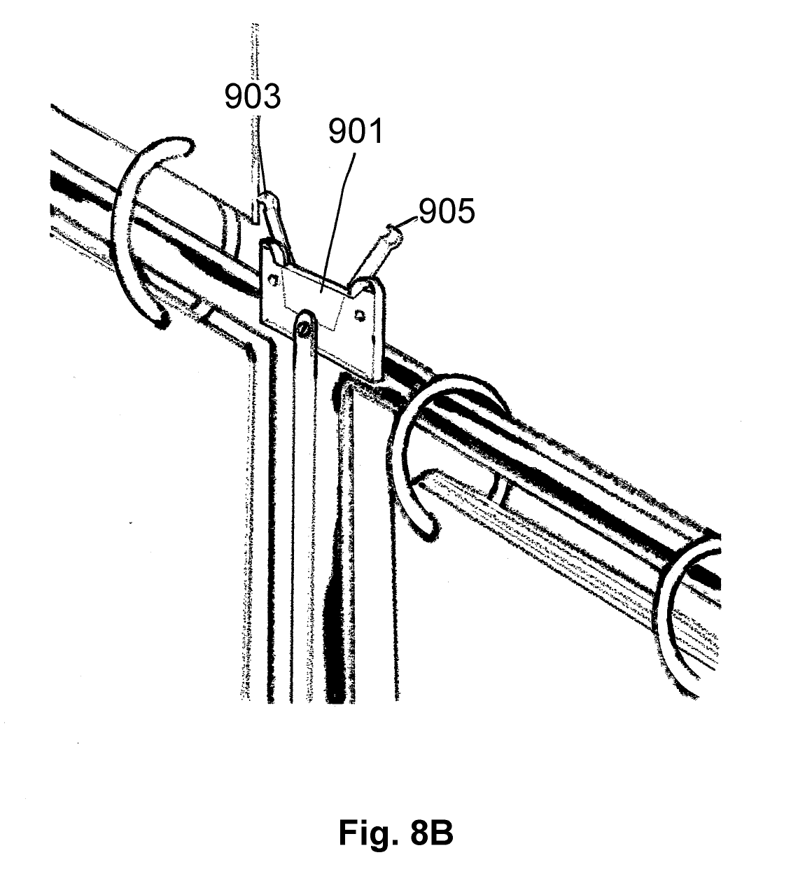

FIGS. 7 and 8A-B illustrate a scoreboard 800 according to a third embodiment. Similar to the scoreboards 100 and 600, the scoreboard 800 is manually operated but has electronic componentry. The scoreboard 800 can include a scoreboard body 810 that has a center vertical structure 812, and first and second top side display structures 820, 822. The scoreboard 800 can also include a cross structure 824 that can be used to display the names of the players or can be used to display a “home” and/or “visitor” signs, for example. On each of the display structures 820, 822, one or more score cards 830 can be displayed for the respective players/teams. In the illustrated embodiment, which can be used as tennis scoreboard, the score cards 830 can include a group of game indicia cards 831, 832 for display on the display structures 820 and 822, respectively. The score cards 830 can further include a group of set indicia cards 833, 834 for display on the display structures 820 and 822, respectively.

The group of game indicia cards 831, 832 can display numerical game information, such as “0, 1, 2, 3, 4, 5, 6 and 7.” Similarly, the group of set indicia cards 833, 834 can display numerical set information, such as “0, 1, 2, and 3.” In this embodiment, the game indicia cards 831, 832 and the set indicia cards 833, 834 are attached to the display structures 820, 822 via one or more rings attach to each card through which the display structures 820, 822 are inserted through. It should be understood, however, that the indicia cards can be attached to the display structures 820, 822 in any number of ways.

A user can use the game indicia cards 831, 832 and the set indicia cards 833, 834 to display the score by flipping an individual indicia card around the ring from the front side to the back side of the scoreboard 800, which results in the display of the next indicia card in numerical succession. For example, FIG. 7 shows a tennis score at the beginning of a match in which neither player has won a game or a set, and thus each indicia card shows “0”. Accordingly, when a player wins a first game (or a first set), the player flips the “0” game indicia card (or “0” set indicia card) to the back side of the scoreboard 800 to reveal the “1” game indicia card (or “1” set indicia card). In one or more embodiments, the indicia cards are double-sided such that the score on the scoreboard 800 can be read from both the front and the back of the scoreboard 800.

Continuing with this embodiment, as shown in FIGS. 8A and 8B, detection devices 900 and 901 are located along a top portion of the display structures 820, 822, respectively. In particular, the detection devices 900, 901 are located in between the game and set indicia cards on each of the display structures 820, 822. The detection devices 900, 901 each comprise two sensors—one located proximate to the game indicia card set (sensors 902, 903) and one located proximate to the set indicia card set (sensors 904, 905).

The sensors 902, 903 are configured to detect when a respective game indicia card is “flipped”, which indicates a change in the game score. In particular, the sensors 902, 903 are positioned such that when a game indicia card 831, 832 is flipped over, the sensor 902, 903 is configured to detect the flip of the game indicia card. Similarly, the sensors 904, 905 are configured to detect when a respective set indicia card 833, 834 is “flipped”, which indicates a change in the set score. The sensors 902-905 can be configured to detect the flipping of the indicia card in various ways. For example, the sensors 902-905 can be configured to detect flipping of the indicia card upon contact of the indicia card with the sensor, as shown in FIGS. 8A and 8B. As such, in this embodiment, the sensors 902-905 are positioned such that an edge of the respective indicia card must make contact with its respective sensor in order to be flipped. In another embodiment, the sensors 902-905 can detect flipping of the indicia card by motion detection.

Similar to the other embodiments above, when a sensor 902-905 detects the flip of a game and/set indicia card, the detection device 900, 901 is configured to send a signal to a master controller 355 (e.g., via a wire) to indicate a score change. As shown in FIG. 7, the master controller 355 can be located at a bottom portion of the center vertical structure 812. Similar to the detection devices of the above embodiments, the sensors 902-905 can each have a unique identifier, such that detection of the flipping of a card by a particular sensor 902-905 allows the master controller 355 to how the score of the match has changed (e.g., which player or team's score has changed and whether the set and/or game score has changed). For example, upon detection of the flipping of game indicia card 831 by detector 903, a signal is transmitted from detector 901 to master controller 355 which indicates that the game score for that particular player has changed. Since each sensor corresponds to either a game indicia or set indicia for a particular player, the score of the match (game) is readily recorded and/or stored by the master controller 355.

In one or more implementations of scoreboard 800, each sensor 902-905 corresponds to a group of game or set indicia cards, rather than one specific game or set indicia cards. Accordingly, the master controller 355 can comprise a counter that can determines the number of times a game or set indicia card for each player has been flipped. The counter thus enables the master controller 355 to send a signal to one or more devices for the accurate display of the score on one or more remote devices, as discussed in greater detail below. In at least one alternative implementation, each game and set indicia card can comprise its own sensor such that when that particular indicia card is flipped in proximity to its corresponding sensor 902-905, the sensor 902-905 is configured to determine the particular indicia card that was flipped. In this implementation, the sensor 902-905 is then configured to send a signal to the master controller 355 that corresponds to the particular indicia card that was flipped. Thus, in this implementation, a counter is not required in the master controller 355.

### Tennis Scoreboard—Fourth Embodiment

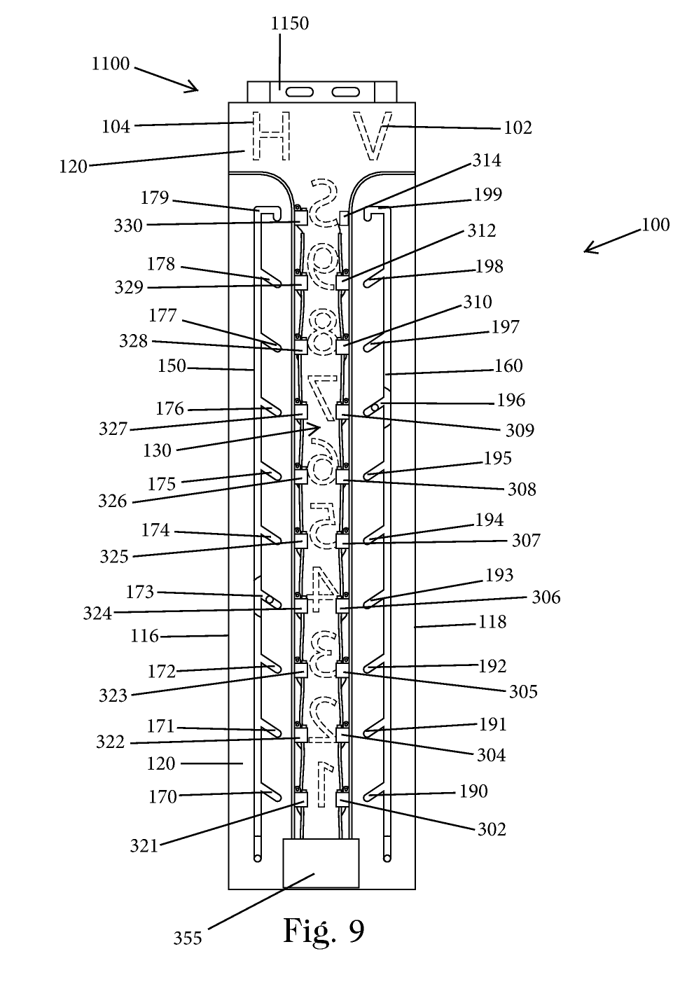

FIGS. 9 and 10 illustrate a scoreboard 1100 according to a fourth embodiment. The scoreboard 1100 is similar to previously described scoreboards, such as scoreboard 100, and therefore like elements are numbered alike. In this embodiment, a post or shaft 201 that connects one disk 203 to a second disk 205 (all of which formed the indicator 200) includes a magnetic component. More specifically, the shaft 201 carries a magnet 207. The shaft 201 can be formed as a tubular structure and therefore, the magnet 207 is disposed internally within the shaft 201. The shaft 201 thus surrounds the magnet 207 and can be formed of a plastic material or other suitable materials.

When each indicator 200 contains magnet 207, the corresponding detection device is of a type that is configured to sense the presence of a magnetic field. In other words, each of the detection devices that are associated with one corresponding side track can thus be thought of as being a magnetic sensor that is configured to sense the magnet 207 in the corresponding side track. Thus, the detection device detects the magnetic field. Thus, each of the detection devices 302, 304, 305, 307, 308, 309, 310, 312, 314, 321, 322, 323, 324, 325, 326, 327, 328, 329, 330 can be in the form of a magnetic sensor and each of the indicators 200, includes a magnet.

It will be understood that each detection device is in communication with the master controller, generally shown at 355, such that when the detection device detects a magnetic field, the respective detection device sends a signal to the master controller 355 (PCB) that is preferably integrated into the scoreboard itself (however, it can also be configured as a unit that is attached to the scoreboard body). While each detection device can be directly connected to the master controller 355 via a wired connection, in another embodiment, the detection devices can be grouped and connected to a multiplexer. As is known in telecommunications and computer networks, multiplexing is a method by which multiple analog or digital signals are combined into one signal over a shared medium, such as wires to the master controller. Thus, sets of the detection devices can be grouped together and form an identifiable group (e.g., S1, S2, . . . ) and within each group there are identifiable detection devices, such as A1, A2, A3, etc. As a result of the multiplexing arrangement, the master controller 355 is able to determine the precise detection device (sensor) that was tripped (actuated). For example, it may be that the detection device at S1, A3 was actuated meaning that one indicator is placed in the side slot that corresponds to the detection device. The master controller 355 can continuously scan all of the detection devices to see which ones have been actuated. This arrangement can be thought of as being a binary arrangement in which detection device (sensor) actuation is represented by a “1” and no actuation is represented by a “0”.

It will also be appreciated in view of the figures that more than one detection device associated with one player can be actuated at any given time. For example, the side track 179, 199 receives one indicator 200 to indicate that a respective tennis player has won one set. In a subsequent set(s), another indicator is used to register the number of games each player has won. Thus, the present invention can be configured in one or more embodiments to differentiate between a set score and a game score, and since the individual detection devices have specific locations, the master controller 355 can easily keep score and send score information to a display that can be part of the scoreboard or send it to an external device, such as a computing device, server, etc., over a network.

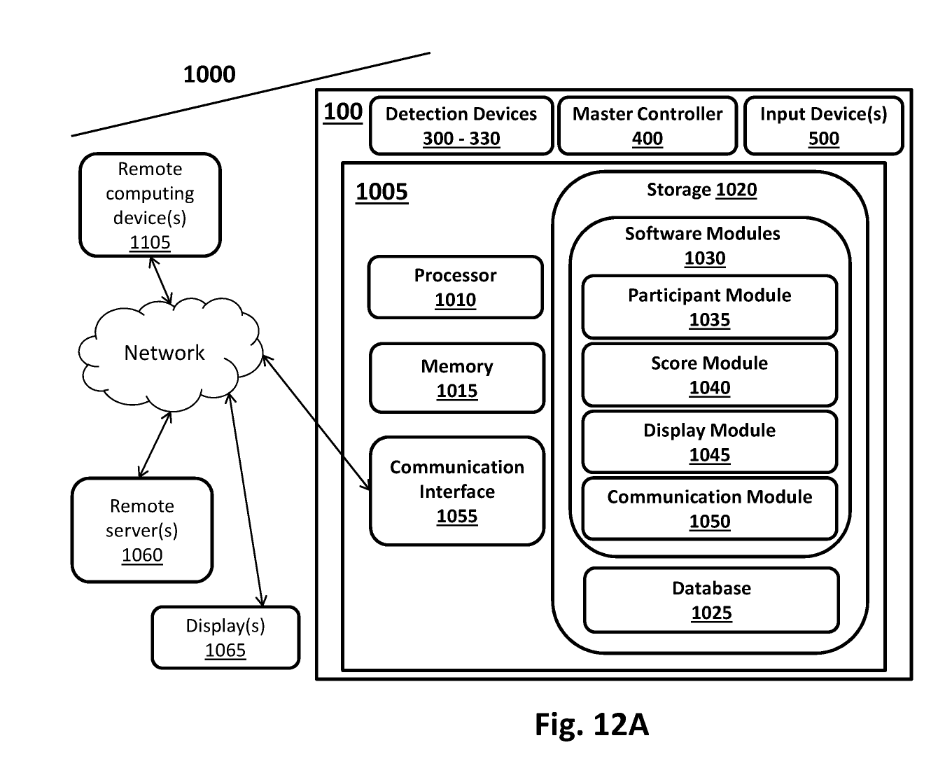

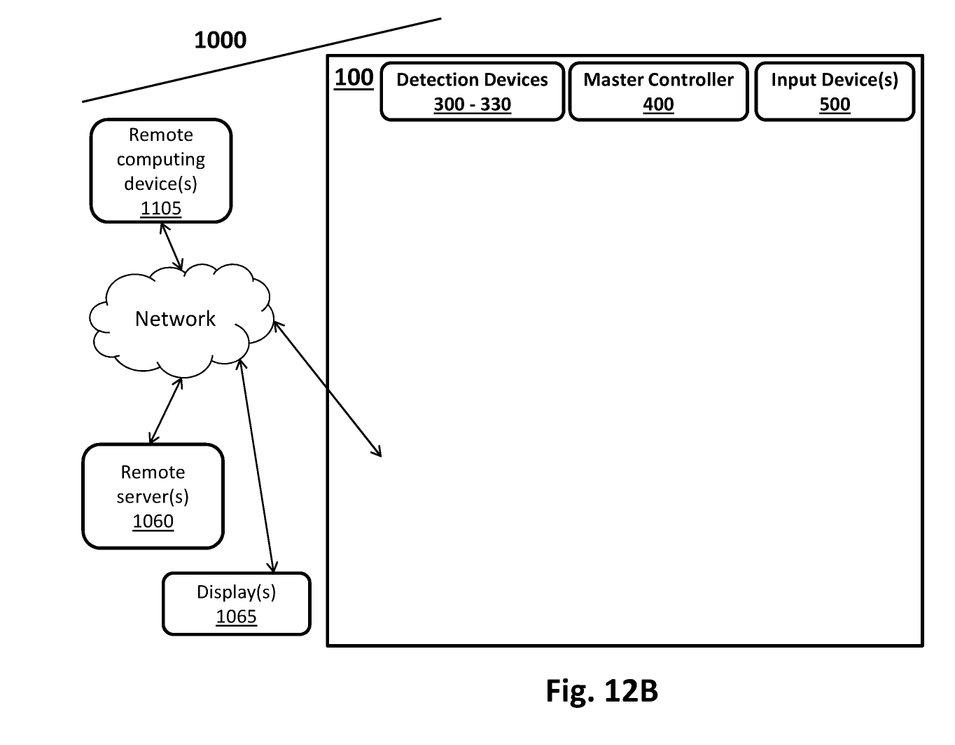

Thus, when one indicator 200 is inserted into one of side track 170-179 and 190-199, the magnet 227 in the indicator 200 activates the magnetic sensor on the scoreboard body which is near the tip of one of the side tracks. This activation is sensed by the master control (e.g., controller 355 or controller 355 of FIG. 12A/B), and interpreted as a score based on the software on the master controller. It will also be understood that the detection devices can be in the form of capacitive sensors. Capacitive sensing (also known as capacitance sensing) is a technology based on capacitive coupling, that can detect and measure anything that is conductive or has a dielectric different from air.

FIG. 9 also depicts one type of energy source to power the scoreboard. In particular, a solar panel 1150 can be provided and mounted to the scoreboard and operatively connected to the working components of the scoreboard, including the master controller 355. For example, the solar panel 1150 can be located along the top of the scoreboard.

As described herein, other energy harvesting devices can be implemented instead of solar power to provide a self-harvesting energy source. For example, thermal energy, wind, etc., can be utilized to power the scoreboard. A built-in battery is connected to the solar panel 1150 and acts to store the energy harvested by the solar panel for later use.

### Tennis Scoreboard—Fifth Embodiment

As shown in FIG. 11, in accordance with another embodiment, the scoreboard takes the form of a low power e-ink display 1400. As is known, e-ink is a display technology that aims to replicate the appearance of ink printed on paper. The core of e-ink technology is based on small capsules filled with a clear fluid containing very small particles, each about as wide as a human hair. Each e-ink display is made up of millions of such capsules in a thin film, with the particles inside the capsules capable of being different colors and different electric charges. Electrodes are placed above and below the capsule film. When a positive or negative electric field is applied to an individual electrode, the color particles with the corresponding charge will move either to the top or bottom of a capsule, making the surface of the e-paper display appear a certain color.

As shown in FIG. 11, the display (scoreboard) 1400 generally has a home side (e.g., the left side) and a visitor side (e.g., the right side) and under each there are a pair of display areas. For example, on the left side of the display that represent the home score, there is a first display area 1410 and a second display area 1420 below the first display area. The first display area 1410 can represent a set score area in which a set score for the home is displayed, while the second display area 1420 can represent a game score area in which a game score for the home is displayed. The visitor's side has similar displays in that a third display 1430 represents a set score area for the visitor and a fourth display 1440 represent a game score for the visitor. As with the other scoreboards disclosed herein, the scoreboard (display) 1400 can be connected over a network to allow remote monitoring of the score of the match.

As mentioned previously, while the embodiments are described with reference to Tennis, the scoreboard can be used in other sports.

### Input Device

The scoreboard of each of the above embodiments (100, 600, 800) can also include an input device 500 that allows information to be inputted (see FIG. 12A/12B). The input device 500 communicates with the master controller 355 such that information that is input can be processed and/or stored in memory or the like. For example, the input device 500 can be used to input location information and/or player identification information. The input device 500 can thus be a keyboard, scanner, reader, touchscreen, joystick, etc.

In one embodiment and before a match begins, each player inputs his/her player identification information to the scoreboard 100. This can be done in any number of different ways including but not limited to the following: each player can carry a uniquely identified card (e.g., a plastic RFID card) and the input device 500 can be in the form of an RFID reader. Each player merely positions the card close to or in contact with the input device (reader) 500 which reads the unique player identification information contained in the card, thereby allowing the scoreboard to recognize the player. Alternatively, a keyboard or touch screen can be used to enter the unique player identification information.

In terms of assigning sides and whether one player is the “home” player and a “visitor” player, the input device 500 can allow such information to be entered. For example, when readers are used, there can also be a display (touch screen) that includes a virtual button marked “home” and a virtual button marked “visitor”. The user can simply press one of the “home” or “visitor” buttons and then scan his or her card. The processor 355 will thus link this person to the selection (home or visitor) that was made and this information can be stored in memory. Alternatively, there can be separate input devices 500 for the home side and the visitor side. In this embodiment, the home player simply scans his or her card on the input device 500 that is linked to the home side. The visiting player does the same and uses the visitor player input device 500. In this manner, one specific player is linked to the electronic scoring mechanism associated with the “home player” and the other player is linked to the electronic scoring mechanism associated with the “visitor player”.

Based on the previously described detection devices and the construction of the scoreboard and presence of the master controller, the scoreboard (100, 600, 800, 1100) maintains its traditional manual character in that each player has to manually move the indicator (or indicia cards) to reflect a change in the score. However, the electronic scoring mechanism equipment (e.g., the detection devices and the master controller) that has been added to the scoreboard permits automatic, electronic detection of the current score and the master controller 355, as described below, is configured to transmit such score information to allow for compiling and display of such information on various types of computing devices at other locations.

As mentioned herein, the scoreboard and teachings of the present invention can be implemented in other game settings.

### Computer Implemented Scoreboard System

In one or more embodiments, the scoreboard of the present application is part of a system that employs hardware and software that provide functionality to transmit and receive score data related to one or more sporting events (e.g., matches). The score data can then be compiled, sorted, and displayed to one or more persons on a display screen or to one or more user on the user's computing device (e.g., via a scoreboard app), such as a personal computer, tablet, smartphone, or other mobile computing device. In certain embodiments, multiple scoreboards can be included in the system. For example, at a tennis facility having multiple tennis courts, each court has its own scoreboard. As such, in this example, the present system allows for the score of each of the matches to be transmitted (e.g., wirelessly) from each scoreboard to a computing device configured to display the scores from each tennis match on one or more display screens (e.g., a larger TV monitor or a display screen of a PC, tablet, or smartphone, etc.).

FIG. 12A shows a block diagram illustrating an exemplary configuration of a system 1000 for transmitting and displaying score data in conjunction with the scoreboard(s) 100 in accordance one or more embodiments disclosed herein. While FIG. 12A is shown in connection with the scoreboard embodiment 100, it should be understood these configurations also apply equally to other scoreboard embodiments, including embodiments 600, 800, and 1100, and an embodiment illustrated in block diagram form in FIG. 12B.

FIG. 12A shows the scoreboard 100 including the detection devices 300-330, the master controller 355, the input device 500, and a computing device 1005. As shown in FIG. 12A in one or more embodiments, computing device 1005 is integrated into the scoreboard 100. The scoreboard 100 can be connected to the computing device 1005 via a wired connection or can be remote from the computing device 1005, and thus connected to the computing device 1005 via a wireless connection over a network. The scoreboard 100 can also be configured to transmit data to (or receive data from) the computing device 1005 via master controller 355. Multiple of such scoreboard 100 and master controller 355 units can form a cluster and communicate with each other to form a mesh network and enable the flow of data to the edge of the mesh where the end unit transfers the data to a respective computing device 1005.

An exemplary computing device 1005 of the scoreboard 100 includes a processor 1010, which is operatively connected to various hardware and software components, also referred to as modules, to configure to computing device 1005 and enable operation of the systems and methods described herein. The processor 1010 implements instructions that perform various operations relating to receiving participant data and score data from the input device 500 and detection devices 300-330, respectively, communicating with one or more remote devices, and/or displaying scoreboard data. Without loss of generality, the processor 1010 can be a number of processors, a multi-processor core, or some other type of processor configuration, depending on the particular implementation.

In certain implementations, a memory 1015 and/or a storage medium 1020 are accessible by the processor 1010, thereby enabling the processor 1010 to receive and execute instructions stored on the memory 1015 and/or on the storage 1020. The memory 1015 can be, for example, a random access memory (RAM) or any other suitable volatile or non-volatile computer readable storage medium. In addition, the memory 1015 can be fixed or removable.

The storage 1020 can take various forms, depending on the particular implementation. For example, the storage 1020 can contain one or more components or devices such as a hard drive, a flash memory, a rewritable optical disk, a rewritable magnetic tape, or some combination of the above. The storage 1020 also can be fixed or removable. Also preferably stored on the storage 1020 is a database 1025. In certain embodiments, the database 1025 contains and/or maintains various data items and elements, such as participant information, score information, league information, game location, and the like that are utilized throughout the various operations of the scoreboard 100. For example, participant information and/or location information received from the input device 500 (e.g., via master controller 355) can be stored by the processor 1010 in the database 1025. Likewise, score information received from the detection devices 300-330 (e.g., via master controller 355) can also be stored by the processor 1010 in the database 1025. It should be noted that although the database 1025 is depicted as being configured locally to the computing device 1005, in certain implementations the database 1025 and/or various of the data elements stored therein can be stored on a computer readable memory or storage medium that is located remotely and accessible by the computing device 1005, such as through a network, in a manner known to those of ordinary skill in the art.

One or more software modules 1030 can be encoded in the storage 1020 and/or in the memory 1015. Alternatively, one or more software modules 1030 can be stored remotely and accessible by the computing device 1005, such as over a network. The software modules 1030 can comprise one or more software programs or applications having computer program code or a set of instructions executed in the processor 1010. Such computer program code or instructions for carrying out operations or aspects of the systems and methods disclosed herein can be written in any combination of one or more programming and/or scripting languages, as would be understood by those skilled in the art.

In the example embodiment shown in FIG. 12A, included among the software modules 1030 are a participant module 1035, a score module 1040, a display module 1045, and a communication module 1050 that are executed by the processor 1010. In particular, participant module 1035 serves to configure the processor 1010 to receive participant information from the input device 500 (e.g., via master controller 355), transmit the participant information to one or more remote devices, and/or save the participant information to the database 1025. Score module 1040 serves to configure the processor 1010 to receive score information from the detection devices 300-330 (e.g., via master controller 355), transmit the score information to one or more remote devices, and/or save the score information to the database 1025. The display module 1045 configures the processor 1010 to display participant information and/or score information on one or more remote (or local) display screens. Communication module 1050 serves to configure the processor 1010 to transmit and/or receive signals from one or more remote devices.

As noted herein, software modules 1030 are depicted as being stored locally by the computing device 1005, the disclosed embodiments are not so limited, as one or more of the modules can be stored on one or more remote storage mediums that are accessible to the processor 1010. The program code can execute entirely on the computing device 1005 as a stand-alone software package, partly on the device 1005 and partly on one or more remote computing devices, or entirely on such remote computing devices. In the latter scenario, the remote computing devices can be connected to the device 1005 through any type of wired or wireless network (not shown), including a local area network (LAN) or a wide area network (WAN), or the connection can be made to an external computer (for example, through the Internet using an Internet Service Provider). For instance, one or more aspects of the display module 1045 can be implemented by one or more remote devices, such as a remoted display screen, such that the participant information (data) and/or score information (data) are shown on the display screen.

In certain embodiments, one or more of the software modules 1030 can be downloaded over a network to the storage 1020 from another device or system via a communication interface 1055 for use within the system 1000. For instance, program code stored in a computer readable storage device in a remote server can be downloaded from the remote server to the storage 1020 over the network.

The communication interface 1055 is also operatively connected to the processor 1010. The communication interface 1055 can be any interface that enables communication between the computing device 1005 and external devices, machines, and elements. In certain implementations, the communication interface 1055 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting the computing device 1005 to other computing devices and/or communication networks, such as private networks and the Internet. Such connections can include a wired connection or a wireless connection (e.g., using the IEEE 802.11 standard known in the relevant art) though it should be understood that communication interface 1055 can be practically any interface that enables communication to/from the processor 1010. Accordingly, at various points during the operation of the systems and methods disclosed herein, the computing device 1005 can communicate, directly or indirectly, with one or more remote devices.

The system 1000 for transmitting and displaying scoreboard data in conjunction with the scoreboard(s) 100 can also include one or more remote servers 1060, one or more displays 1065, and one or more remote computing devices 1105. In at least one embodiment in which multiple scoreboards 100 are included in system 1000, the scoreboards 100 can be operatively connected to the one or more remote servers 1060 such data from the scoreboards 100 are transmitted from the scoreboard 100 to the remote server(s) 1060, such as via master controller 335 and/or computing device 1005 to the remote server(s) 1060, which are then configured to transmit the data to remote computing device(s) 1105 and/or display(s) 1065. The displays 1065 can be configured to display scoreboard data from scoreboard 100 substantially in real-time as discussed in greater detail herein. In at least one embodiment, the scoreboard(s) 100 can be configured (e.g., via computing device 1005) to transmit data directly to the remote computing device(s) 1105 and display(s) 1065 over a wired network or wireless network (e.g., Internet). It should be noted that although the display(s) 1065 are depicted as being located remotely and connected to the computing device 1005 and scoreboard 100 through a network in a manner known to those of, in certain implementations the display(s) 1065 can be configured locally to the device 1005 and the scoreboard 100.

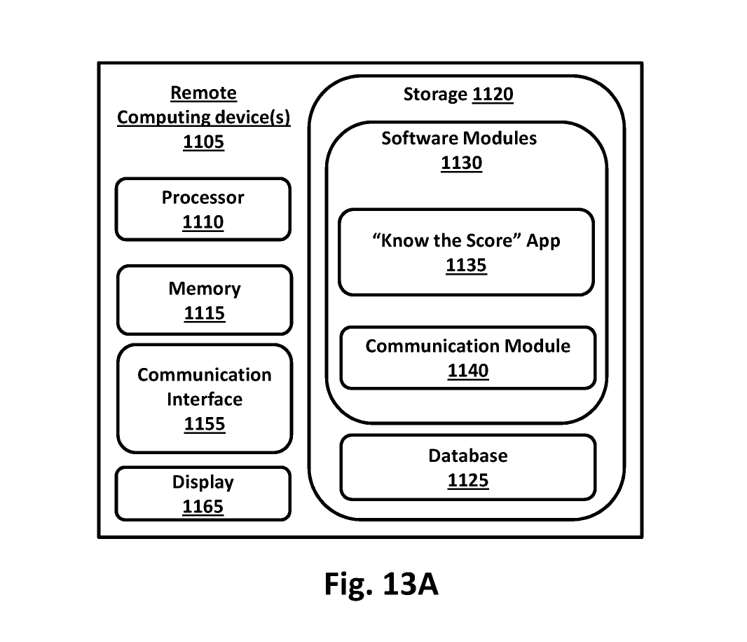

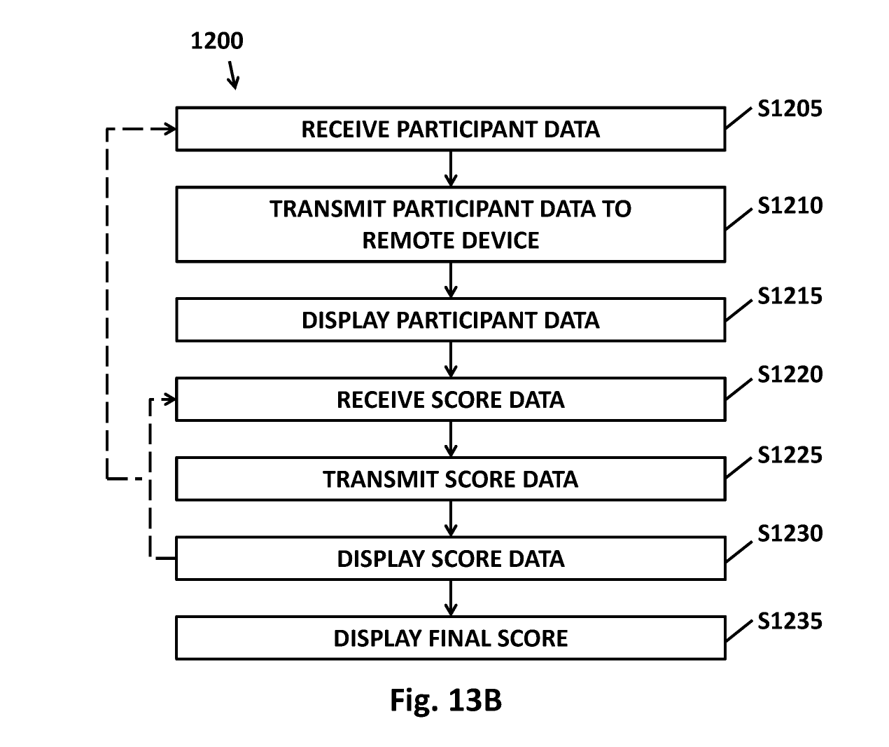

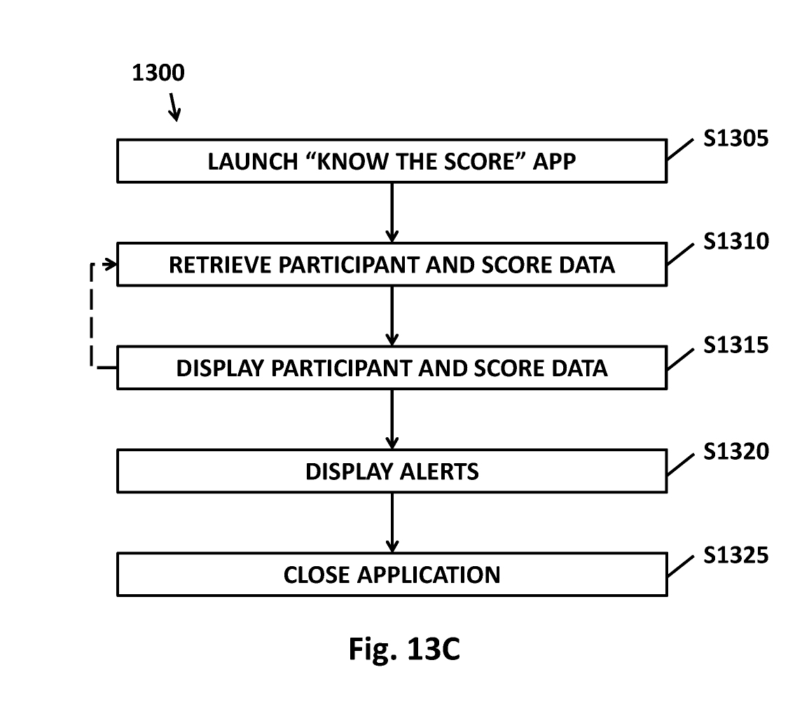

The one or more remote computing devices 1105 can be any type of computing device, such a personal computer, tablet, smartphone, or other mobile computing device. An exemplary remote computing device 1105 is shown at FIG. 13A. Like the computing device 1005, the remote computing device 1105 can comprise a processor 1110 and memory 1115 and/or storage 1120. The remote computing device 1105 can further comprise a database 1125, and one or more software modules/applications 1130 that can be executed by the processor 1110. The software modules 1130 can include a “Know the Score” app 1135 and a communication module 1140. In embodiments in which the remote computing device 1105 is a mobile device such as a smart phone the “Know the Score” app 1135 is a mobile app. The remote computing device 1105 can further comprise a communication interface 1155 and a display 1165.

The operation of the exemplary system 1000 and the various elements and components described above will be further appreciated with reference to the methods for displaying one or more real-time scores from the scoreboard 100 on one or more displays and/or remote devices.

Several of the logical operations described herein are implemented (1) as a sequence of computer implemented acts or program modules running on the various devices of the system 1000 and/or (2) as interconnected machine logic circuits or circuit modules within the system. The actual implementation is a matter of design choice dependent on the requirements of the device (e.g., size, energy, consumption, performance, etc.). Accordingly, the logical operations described herein are referred to variously as operations, steps, structural devices, acts, or modules. As referenced above, the various operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Turning now to FIG. 13B, a flow diagram illustrates a method 1200 for displaying one or more real-time scores from the scoreboard 100 on one or more displays 1065 in accordance with at least one embodiment disclosed herein. With reference to FIGS. 12A, 12B and 13B, the process begins at step S1205, where the computing device 1005 receives participant data (e.g., names of the players and/or teams in the game or match, location of the game or match). In particular, participant data can be provided via the input device 500 of the scoreboard 100 as discussed herein. The processor 1010 of computing device 1005, executing one or more software modules 1030, including preferably participant module 1035 is configured to receive the participant data from the input device 500 via a transmission from master controller 355.

At step S1210, the processor 1010, executing one or more software modules including participant module 1035 and communication module 1050, is configured to transmit the participant data to one or more displays 1065. At step S1215, the one or more displays 1065 are configured to display the participant data. More specifically, in one or more embodiments, the processor 1010, executing one or more software modules including preferably participant module 1035 and display module 1045, can be configured to cause the display(s) 1065 to show the participant data. For example, in an implementation in which the system 1000 is utilized at a tennis facility, the display(s) 1065 (e.g., flat-screen televisions) can show the names of the participants in one or more matches as well as the court that the particular participants are playing their matches on. In implementations in which the displays 1065 are located remotely from the computing device 1005, the participant data is transmitted wirelessly over a network (e.g., Internet). In an implementation in which the displays 1065 are configured locally to the computing device 1005, the transmission of participant data can occur over wired connection. The scoreboard itself can include a local display 1065.

At step S1220, the computing device 1005 is configured to receive game data (e.g., score in the game or match, time remaining in the game or match) from the scoreboard 100. The score data can be provided to the scoreboard 100 via the one or more detection devices 300-330 of the scoreboard 100. The processor 1010 of computing device 1005, executing one or more software modules 1030, including preferably score module 1040, is then configured to receive the score data from the detection device(s) 300-330 (e.g., transmitted via master controller 355).

At step S1225, the processor 1010, executing one or more software modules including preferably score module 1040 and communication module 1050, is configured to transmit the received score data to the one or more displays 1065.

At step S1230, the one or more displays 1065 are configured to display the score data. More specifically, in one or more embodiments, the processor 1010, executing one or more software modules including preferably score module 1040 and display module 1045, can be configured to cause the display(s) 1065 to show the score data. For example, in an implementation in which the system 1000 is utilized at a tennis facility, the display(s) 1065 (e.g., flat-screen televisions) can show the score of each of the participants in the one or more matches. In one or more embodiments, the score data is displayed concurrently with the corresponding participant data. As shown in FIG. 13B, in certain embodiments the process can optionally return from step S1230 to step S1220 and/or step S1205. Returning to step S1220 allows for new score data to be received by the computing device 1005, which are then transmitted to the display(s) 1065. For instance, as the score changes throughout the game or match, the changes in the score detected by the detection devices 300-330 are received by the computing device 1005 and then transmitted to the display(s) 1065. Similarly, returning to step S1205 allows for new participant data (e.g., player substitutions) to be received by the computing device, which are then transmitted to the display 1065. For example, if one or more players are substituted in (or out) in a game, the changes can be inputted via input device 500, and then transmitted to the computing device 1005 and, subsequently, to the display(s) 1065.

At step S1235, the processor 1010, executing one or more software modules including preferably score module 1040 and display module 1045, can be configured to cause the display(s) 1065 to show the final score. For example, upon receiving score data for a match that indicates that the match is over (e.g., a player in the tennis match has won two sets in a best-of-three set match), the display(s) 1065 are configured to show the final score with an indication that the match has ended.

It should be noted that in at least one embodiment of method 1200, the receiving steps (S1205 and S1220), the transmission steps (S1210 and 1225), and the display steps (S1215 and 1230), respectively, can be combined such that the score data and participant data are received, transmitted, and displayed in tandem.

Further, in at least one alternative embodiment, the participant data and the score data can be provided on a website provided on remote server 1060. The website providing the participant and score data can then be displayed on display(s) 1065. In such embodiment, the remote server information can be configured with one or more modules 1030, or variants thereof, thereby configuring the remote server 1060 to at least partially operate as computing device 1005.

Turning now to FIG. 13C, a flow diagram illustrates a method 1300 for displaying one or more real-time scores from the scoreboard 100 on one or more remote computing devices 1105 via a mobile app in accordance with at least one embodiment disclosed herein. With reference to FIGS. 13A and 13C, the process begins at step S1305, where the remote computing device 1105 is configured to launch the “Know the Score” app. More specifically, the processor 1110 of the remote computing device 1105, executing one or more software modules 1130, is configured to launch the “Know the Score” mobile app 1135. In one or more implementations, the mobile app 1135 can be launched in response to user input on the remote computing device 1105.

At step S1310, the processor 1110, executing one or more software modules including preferably the “Know the Score” app 1135 and communication module 1140, is configured to retrieve participant data and score data from one or more games/matches from the scoreboard(s) 100. The participant and score data from the scoreboard 100 can be retrieved by the processor 1110 via one or more signals transmitted from the computing device 1005. As discussed above, the computing device 1005 of the scoreboard 100 receives participant data and score data from the input device(s) 500 and the detection devices 300-330, respectively. This participant data and score data can then be transmitted by the computing device 1005 (e.g., via communication interface 1055) to the remote computing device(s) 1105.

At step S1315, the processor 1110, executing one or more software modules including preferably the “Know the Score” app 1135, is configured to display the participant data and score data of the one or more matches or games. In particular, upon retrieving the participant and score data from the computing device 1005, the processor 1110 of the remote computing device 1105 is configured to display the participant and score data in the form a score for each respective match. For example, the processor 1110 is configured to display the participants of a particular match and the score of that match on its display 1165 (e.g., display screen). In certain embodiments, the processor 1110 is configured to show the score data (and participant data) of multiple matches (or games) at one time on its one or more displays 1065.

In certain embodiments, the process 1300 can return periodically from step S1315 to step S1310 to retrieve additional participant data and/or score data. This periodic return to step S1310 allows the user to receive updates to the score as the match progresses. In one or more implementations, the processor 1110 executing the “Know the Score” app 1135 can be configured to automatically return to step S1310 (from S1315) at scheduled intervals (e.g., every 60 seconds) such that the score can be updated substantially in real-time. In at least one implementation, the processor 1110 executing the “Know the Score” app 1135 can be configured to return to step S1310 upon receiving a signal from computing device 1005 indicating that the score data and/or participant data has be modified. For example, upon receiving new score data from the one or more detection devices 300-330, the computing device 1005 can be configured to transmit a signal to remote computing device 1105 (e.g., via communication interface 1055) indicating that new score data is available. Upon receiving the signal, the processor 1110 of remote computing device 1105 is then configured to retrieve the new score data, which is subsequently displayed via display 1165 at step S1315. In at least one implementation, the process 1300 can return from S1315 to S1310 upon user input (e.g., a request to update the score). In one or more embodiments, the loop between steps S1310 and S1315 can be continued until the match is over, at which point the processor 1110 is configured to display the final score at step S1315.

At step S1320, the processor 1110, executing one or more software modules including preferably “Know the Score” app 1135, is configured to display one or more alerts on display 1165. In one or more embodiments, the alerts can be displayed when the “Know the Score” app is not in use on the remote computing device 1105 and/or when the remote computing device 1105 is inactive (e.g., in a “sleep” mode). For example, when “Know the Score” app 1135 is not being interacted with by the user of the remote computing device 1105, the processor 1110 can be configured to receive new participant and/or score data periodically from computing device 1005 of the scoreboard 100. Accordingly, upon receiving new participant and/or score data, the processor 1110 can be configured to display one or more alerts to the user on display 1165, indicating a change in the score and/or participants in a match (or game). In one or more implementations, the user, via user input in the remote computing device 1105, can determine the matches/games for which alerts will be displayed and the frequency of the alerts being displayed. For instance, the user via user input can configure the processor 1105 to only display alerts for the matches of selected teams, players, and/or leagues, and receive only one alert for each particular game or match (e.g., the final score when the match is over). The user, via user input, can also opt to receive alerts more frequently for each selected match (e.g., receiving a score update at the end of each set of a tennis match).

Finally, at step S1325, the processor 1110, executing one or more software modules, is configured to close the “Know the Score” app 1135. In one or more implementations, the “Know the Score” app 1135 can be closed in response to user input on remote computing device 1105. In at least one implementation, the processor 1110 can be configured to close the “Know the Score” app 1135 automatically upon inactivity with the app for a predetermined period of time and/or upon turning off of the remote computing device 1105.

It will also be understood that a power source is provided for the scoreboard. For example, the power source can be in the form of a battery that can be stored in a housing associated with the scoreboard or the scoreboard can include an electrical plug for insertion into a standard electrical outlet for powering the scoreboard or solar power panel connected to a battery.

The scoreboard of the present invention can thus be a self-contained unit that is driven by a power source, including solar, that can be placed at a game location, such as a court, and powered up to allow for each participant to keep score and the score data is transmitted from the self-contained scoreboard to a remote location, such as server. As described herein, scores from multiple scoreboards can be received and sorted and displayed to users. The displays can be on site or can be at any remote location, such as on a display of a tablet, a PC, or smartphone, etc. It should be noted that while many of the above examples and methods have been in reference to scoreboards associated with one or more tennis matches, the above methods and systems can be applied similarly to other sporting events.

It is to be understood that like numerals in the drawings represent like elements through the several figures, and that not all components and/or steps described and illustrated with reference to the figures are required for all embodiments or arrangements.

Thus, illustrative embodiments and arrangements of the present devices and methods provide a method for conveying scoring information. The flowchart in the figures illustrates the operation of possible implementations of methods according to various embodiments and arrangements. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present disclosure, which is set forth in the following claims.

What is claimed is:

1. A scoreboard comprising:
a scoreboard body having first player identification indicia, second player identification indicia, and scoring indicia;
a first player indicator that is movable relative to the scoreboard body for indicating a current score of a first player;
a second player indicator that is movable relative to the scoreboard body for indicating a current score of a second player;
at least one first detection device for recording manual movement of the first player indicator which indicates a change in the current score of the first player;
at least one second detection device for recording manual movement of the second player indicator which indicates a change in the current score of the second player; and
a master controller operatively connected to the at least one first detection device and the at least one second detection device, the at least one first detection device being configured to send a signal to the master controller when the at least one first detection device detects the first player indicator, the at least one second detection device being configured to send a signal to the master controller when the at least one second detection device detects the second player indicator;
wherein the master controller is configured to perform at least one of the following operations: (a) store the current score of each of the first and second players; and (b) transmit the current score of each of the first and second players over a network.

2. The scoreboard of claim 1, wherein the scoreboard is configured for keeping score of a tennis match.

3. The scoreboard of claim 1, wherein the scoring indicia comprises a numerical game listing along the scoreboard body, the at least first detection devices comprises a first set of first detection devices arranged such that one first detection device is uniquely assigned to one corresponding game listing, and the at least second detection devices comprises a first set of second detection devices arranged such that one second detection device is uniquely assigned to one corresponding game listing.

4. The scoreboard of claim 3, wherein each game listing has associated therewith: (a) one first detection device located along a first path over which the first player indicator can travel and (b) one second detection device located along a second path over which the second player indicator can travel.

5. The scoreboard of claim 1, wherein each of the at least one first and second detection devices comprises a sensor.

6. The scoreboard of claim 5, wherein the sensor comprises one of a mechanical sensor, an optical sensor, magnetic sensor and a capacitive sensor

7. The scoreboard of claim 6, wherein the sensor comprises a switch having a pivotable arm that is tripped by one of the first player indicator and the second player indicator.

8. The scoreboard of claim 6, wherein the sensor comprises an optical sensor that is tripped by one of the first player indicator and the second player indicator when a portion of one of the first player indicator and the second player indicator breaks a beam emitted by the optical sensor.

9. The scoreboard of claim 6, wherein the sensor comprises magnetic hall sensor switch that is configured to detect a magnet that is carried by one of the first player indicator and the second player indicator when the magnet is brought within a predefined distance of the magnetic hall sensor.

10. The scoreboard of claim 6, wherein the sensor comprises a capacitive sensor switch that is configured to detect and be tripped by a capacitive effect due to the presence of one of the first player indicator and the second player indicator.

11. The scoreboard of claim 1, wherein the scoreboard includes a network communication module that permits the scoreboard to connect to a network via a wireless communication method, i.e., Wi-Fi, Cellular, Mesh.

12. The scoreboard of claim 1, wherein the scoreboard includes an input device connected to the processor.

13. The scoreboard of claim 12, wherein the input is configured to allow each player to input unique player identification information.

14. The scoreboard of claim 13, wherein the input comprises an RFID reader that is configured to read the unique player identification information encoded in a card.

15. The scoreboard of claim 1, wherein the scoreboard body includes a first vertical slot having a plurality of first side slots extending therefrom at spaced intervals along the first vertical slot and a second vertical slot having a second plurality of side slots extending therefrom at spaced intervals along the second vertical slot, the first player indicator traveling within the first vertical slot and is configured for entry into one of the first side slots, the second player indicator traveling within the second vertical slot and is configured for entry into one of the second side slots.

16. The scoreboard of claim 15, wherein each of the first and second side slots has associated therewith one first or second detection device that is uniquely identifiable.

17. The scoreboard of claim 1, wherein the scoreboard comprises a first track in which the first player indicator travels and a second track in which the second player indicator travels, the first and second tracks being spaced apart and parallel to one another, the first player indicator having a pointed tip and the second player indicator having a pointed tip, the scoreboard body including a plurality of first detection devices oriented in spaced arrangement proximate the first track and a plurality of second detection devices oriented in spaced arrangement proximate the second track, each of the first and second detection devices being oriented such that the pointed tip of one of the first and second player indicators can make contact therewith, thereby registering the location of the first or second player indicator and allowing a score change to be calculated.

18. The scoreboard of claim 1, wherein the scoreboard is wirelessly connected through a communication module that utilizes a mesh network technology, wherein a range of a furthest scoreboard is not limited by the range of a local area network.

19. The scoreboard of claim 1, wherein the scoreboard is powered by an energy harvesting technology selected from a group consisting of solar and wind and has a built-in battery to store energy for continuous use.

20. A networked scoreboard system, comprising:
one or more processors operatively coupled to a memory that stores instructions for causing the following steps to be performed by the one or more processors:
receive, over a communication network from at least one computing device, at least one of game information, participant information, and league information, associated with a respective game being played or to be played;
receive, over a communication network substantially in real-time during gameplay of the game, score information representing a change in a score of the game, wherein the score information is received from a master controller that is configured with a scoreboard, in response to an electronic detection of a location or a change in location of an indicator configured with the scoreboard;
process the received score information; and
transmit, over a communication network to at least one device configured with a display, the processed score information, wherein the at least one device configured with the display uses the processed score information for display of a current score of the game.
